(19) United States
(12) Patent Application Publication
(10) Pub. No.: US 2026/0081133 A1
(43) Pub. Date: Mar. 19, 2026

(54) ZINC ELECTRODE FOR ALKALINE NICKEL-ZINC BATTERY AND PREPARATION METHOD THEREFOR

(71) Applicant: Dongguan Chao Ba Batteries Co.,Ltd. Shenzhen Innovation Center, Shenzhen (CN)

(72) Inventors: Bin WANG, Shenzhen (CN); Yuzhan ZHANG, Shenzhen (CN); Xiujuan JIANG, Shenzhen (CN); Xian LI, Shenzhen (CN); Ziyue FENG, Shenzhen (CN)

(21) Appl. No.: 19/332,229

(22) Filed: Sep. 18, 2025

(30) Foreign Application Priority Data
Sep. 18, 2024 (CN) 202411301831.2

(51) Int. Cl. H01M 4/04; H01M 4/24; H01M 4/26

(52) U.S. Cl. CPC H01M 4/0404; H01M 4/244; H01M 4/26

(57) ABSTRACT

Disclosed is a preparation method for a zinc electrode, including: a step of dissolving a water-soluble calcium salt of organic acid in deionized water to obtain a first mixed solution; a step of preparing a negative electrode slurry by mixing the first mixed solution, a water-soluble binder, a thickener, and an active material including zinc oxide; and a step of preparing the zinc electrode by applying the slurry to a surface of a current collector and baking it at a high temperature. Further disclosed is a zinc electrode prepared by the preparation method, and use of the zinc electrode in an alkaline nickel-zinc battery. The zinc electrode prepared in the present disclosure can not only effectively improve the deformation thereof and solve the growth problem of zinc dendrites, but also contribute to increasing the utilization rate of an active material of the zinc electrode and improving the cycle performance of the alkaline nickel-zinc battery.

### FIELD OF THE INVENTION

The present disclosure relates to the technical field of chemical batteries, and in particular, to a zinc electrode for an alkaline nickel-zinc battery and a preparation method therefor.

### BACKGROUND OF THE INVENTION

This section provides background information relating to this application that does not necessarily constitute the prior art.

An alkaline nickel-zinc battery is an electrochemical energy storage device including a zinc electrode, and an electrolyte used in the alkaline nickel-zinc battery is an alkaline electrolyte with deionized water as a main solvent. Wherein, the zinc electrode, as a negative electrode part of the nickel-zinc battery, mainly undergoes reversible electrochemical conversion reactions between zinc oxide and metal zinc. The zinc electrode is typically composed of zinc oxide nanoparticles, metal zinc powder, a binder, and additives with certain functionalities, such as metallic elements, metal oxides, or metal hydroxides, especially additives for alleviating the hydrogen evolution side reaction, controlling the deformation of the negative electrode, and inhibiting the growth of zinc dendrites. The alkaline electrolyte is mainly composed of an aqueous solution of an alkaline electrolyte such as sodium hydroxide, potassium hydroxide, and lithium hydroxide, and mainly provides hydroxide ions to participate in the electrochemical reactions at the positive electrode and the negative electrode. Therefore, the alkaline nickel-zinc batteries have the characteristic of intrinsic safety and have wide application prospects in the fields of large-scale electrochemical energy storage, traction batteries, uninterruptible power supplies at data centers, backup power supplies, electric tools, two-wheeled electric bicycles, and the like.

Due to the high solubility of the active material zinc oxide of the zinc electrode in the alkaline electrolyte, freely movable zincate ions Zn(OH)₄²⁻ can be generated. For example, at room temperature, the solubility of zinc oxide is about 54 g/L in a 30 wt. % potassium hydroxide solution, and can be as high as 80 g/L in a 45 wt. % potassium hydroxide solution. Generally speaking, with the increase of the environmental temperature, the solubility of the zinc oxide in the potassium hydroxide solution will be greatly increased. The chemical reaction that occurs upon dissolution is as shown below:

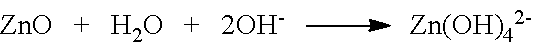

Furthermore, freely movable zincate ions can also be generated at the zinc negative electrode of the nickel-zinc battery during charge and discharge processes, which can easily cause the deformation of the zinc negative electrode during the electrochemical deposition. Even more, zinc dendrites can cause a short circuit of the battery, thus making the zinc electrode exhibit a relatively short charge/discharge cycle life. In view of this technical problem, an existing technical solution includes adding various organic and/or inorganic additives to the zinc electrode and/or the alkaline electrolyte, to inhibit the dissolution of the discharge product of the zinc electrode in the alkaline electrolyte, achieving the purpose of prolonging the cycle life of the alkaline nickel-zinc battery.

Additives commonly used in the prior art are insoluble calcium salts of inorganic acids (including calcium hydroxide, calcium titanate, calcium oxide, etc.). For example, nano-sized zinc oxide and metal zinc powder are used in the zinc electrode as the main negative electrode active materials, and insoluble calcium hydroxide (Ca(OH)₂) is added to the zinc electrode as an additive during the manufacturing process of the zinc electrode. During charge and discharge of the alkaline nickel-zinc battery, the calcium hydroxide additive can bond to zinc oxide and an intermediate product of charge and discharge, to form an insoluble phase, called calcium zincate, which can be identified by X-ray diffraction (XRD) to have the structural formula Ca[Zn(OH)₃]₂·2H₂O. This relatively insoluble phase Ca[Zn(OH)₃]₂·2H₂O can be rapidly formed on the surface of or inside the zinc electrode, avoiding the loss of the negative electrode active materials. On one hand, by effectively inhibiting the solubility of the active material zinc oxide of the zinc electrode in the alkaline electrolyte, and controlling the random diffusion of the zincate ions Zn(OH)₄²⁻ in the alkaline electrolyte, the electrochemical deposition reaction of zinc is limited to a specific area. On the other hand, by anchoring the intermediate product generated by the zinc negative electrode during charge and discharge processes, especially the zincate ions Zn(OH)₄²⁻, the discharge product of the zinc electrode is limited to a specific area of the zinc electrode, and the deformation of the negative electrode and the growth of zinc dendrites can be effectively inhibited to a certain extent, thereby achieving the purpose of prolonging the cycle life of the zinc electrode.

However, the expected results cannot be achieved and the requirements of the existing manufacturing processes cannot be met by means of the additives commonly used in the prior art. Micron-scale or sub-micron-scale insoluble calcium salts of inorganic acids (including calcium hydroxide, calcium titanate, calcium oxide, etc.) and negative electrode active materials (nano-sized zinc oxide and micron metal zinc powder) are present in the form of particles in the negative electrode slurry. Due to the large differences in density and particle size, poor uniformity still occurs during the mixing of the negative electrode slurry, which makes the conversion reaction of the soluble intermediate product Zn(OH)₄²⁻ generated by the zinc electrode in the electrochemical process to calcium zincate become uneven. It can be seen therefrom that the added insoluble calcium salts of inorganic acids have a poor anchoring effect on Zn(OH)₄²⁻, and the internal calcium element cannot interact with Zn(OH)₄²⁻. Therefore, there is a problem of low utilization rate of the calcium element. It needs to be noted that additives such as calcium oxide will generate a large amount of heat in the manufacturing process of the negative electrode slurry, not only consuming water in the slurry, but also easily destroying the molecular structure and viscosity of the organic binder in the slurry, thus seriously affecting the slurry or coating process of the zinc negative electrode and leading to increased difficulty in quality control of zinc electrode sheets. Moreover, calcium hydroxide and calcium oxide, which are strongly alkaline, can easily react rapidly with carbon dioxide in the air during practical preparation of the negative electrode slurry, to generate calcium carbonate (CaCO₃) particles. This will cause the negative electrode slurry to easily deteriorate, and even cause reduced flexibility of the zinc electrode. The hardening of the zinc electrode greatly increases the difficulty in actual winding of battery cell, and the zinc negative electrode is prone to “fracture”. Furthermore, insoluble calcium salts of inorganic acids with strong alkalinity (such as calcium hydroxide and calcium oxide) not only easily cause corrosion to the production equipment made of iron, but also introduce trace impurity elements such as iron, nickel, and manganese in the production equipment into zinc negative electrodes. Consequently, the hydrogen evolution side reaction of the zinc negative electrodes during charge process can be aggravated, which is not conducive to the performance of alkaline nickel-zinc batteries.

### SUMMARY OF THE INVENTION

An objective of the present disclosure is to provide a zinc electrode for an alkaline nickel-zinc battery such that the electrochemical performance of the alkaline nickel-zinc battery using the zinc electrode is significantly improved.

The zinc electrode mainly includes an active material, a functional material including a water-soluble binder and a thickener, and a current collector. With the assistance of the water-soluble binder and the thickener, the active material can be uniformly applied to a surface of or in pores of the current collector, to form the zinc electrode. The active material mainly includes nano-sized zinc oxide and metal zinc powder, and may further include carbon-coated zinc oxide nanoparticles. Besides the water-soluble binder and the thickener, the functional material may further include metal oxide or metal hydroxide additives, and a conductive agent, etc. By introducing a water-soluble calcium salt of organic acid into the zinc electrode, the surface of the active material such as nano-sized zinc oxide or metal zinc powder of the zinc negative electrode can be coated in situ to generate uniform calcium hydroxide, calcium zincate, and a combination thereof, under the action of an alkaline electrolyte (potassium hydroxide, sodium hydroxide, or lithium hydroxide). During discharge process of the alkaline nickel-zinc battery, when zinc oxide or metal zinc is transformed into a soluble intermediate product zincate ions, the zincate ions may immediately interact with calcium element uniformly distributed in the zinc electrode, to quickly generate an electrochemically reversible and relatively insoluble calcium zincate phase (Ca(OH)₂·2Zn(OH)₂·xH₂O, x=2 or 3) on the surface of and in a specific area inside the zinc electrode, by means of in-situ coating. Thus, the solubility of the zinc oxide in the alkaline electrolyte is reduced, and the problem of random diffusion of the zincate ions is solved. The effect of anchoring the soluble intermediate product in the specific area can be achieved, thus effectively reducing the deformation of the zinc electrode and inhibiting the growth of zinc dendrites. During charge and discharge processes, the calcium zincate in the zinc electrode can undergo a reversible charge and discharge reaction according to the following reaction formula:

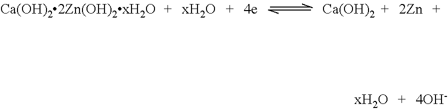

During charge process, the calcium zincate may be electrochemically reduced to a mixture of metal zinc and calcium hydroxide that exists uniformly in the zinc electrode, wherein the calcium hydroxide may be uniformly coated on the surfaces of the active materials such as nano-sized zinc oxide and metal zinc. Not only can the dissolution problem of the nano-sized zinc oxide in the alkaline electrolyte be effectively solved, but also the metal zinc is effectively protected against corrosion in the alkaline electrolyte environment. During discharge process, the discharge product zincate ions formed through the oxidation of the metal zinc may react with the calcium hydroxide in situ to form insoluble calcium zincate. Therefore, in-situ anchoring of freely movable zincate ions through chemical interaction not only effectively inhibits the solubility of zinc oxide in the alkaline electrolyte, but also completely solves the problem of random diffusion of the discharge intermediate product (including zincate ions) of the zinc electrode, thus inhibiting the problems of dendrite growth and negative electrode deformation of the zinc electrode. The purposes of improving the discharge capacity of the alkaline nickel-zinc battery and prolonging the cycle life of the zinc electrode can be achieved.

It needs to be noted that since the calcium element evenly distributed in the zinc negative electrode can chemically interact with hydroxide ions in the alkaline electrolyte, the soluble calcium salt of organic acid contributes to the permeation or wetting of the hydroxide ions in the alkaline electrolyte into the zinc electrode, which is conducive to improving the utilization rate of negative electrode active materials and improving the discharge performance of the alkaline nickel-zinc battery.

A preparation method for the zinc electrode includes:
a step of dissolving a water-soluble calcium salt of organic acid in deionized water to obtain a first mixed solution;
a step of preparing slurry by mixing the first mixed solution, a water-soluble binder, a thickener, and an active material including zinc oxide; and
a step of preparing the zinc electrode by uniformly applying the slurry to a surface of a current collector and baking it at a high temperature.

In the slurry, preferably, a content of the active material is from 80 wt. % to 97 wt. %, based on a total weight of the water-soluble calcium salt of organic acid, the water-soluble binder, the thickener, and the active material. Preferably, a total content of the water-soluble binder and the thickener is from 1 wt. % to 5 wt. %, based on the total weight of the water-soluble calcium salt of organic acid, the water-soluble binder, the thickener, and the active material.

Examples of the water-soluble calcium salt of organic acid used in the present disclosure are water-soluble calcium compounds of organic acid such as calcium lactate, calcium acetate, calcium L-threonate, calcium gluconate, calcium benzoate, calcium glycerophosphate, calcium formate, calcium fumarate, calcium aspartate, calcium malate, calcium maleate, calcium propionate, calcium methanesulfonate, calcium triflate, calcium mellitate, and calcium p-toluenesulfonate.

In one or more embodiments, the water-soluble calcium salt of organic acid may be prepared using an insoluble inorganic calcium salt (e.g., calcium oxide, calcium hydroxide, calcium titanate, calcium carbonate, or calcium bicarbonate) and an organic acid, wherein the organic acid is a water-soluble polyvalent carboxylic acid such as citric acid, acetic acid, ethylenediamine tetraacetic acid, N-hydroxyethylenediamine triacetic acid, nitrilo triacetic acid, 1,3-propanediamine tetraacetic acid, succinic acid, fumaric acid, maleic acid, 1,2,3,4-cyclopentane tetraacetic acid, tartaric acid, glutamic acid, methanesulfonic acid, trifluoromethanesulfonic acid, mellitic acid, and p-toluenesulfonic acid.

A content of the water-soluble calcium salt of organic acid in the first mixed solution is preferably from 0.005 mol/L to 2 mol/L, more preferably from 0.01 mol/L to 1.0 mol/L, and still more preferably from 0.05 mol/L to 0.5 mol/L.

The first mixed solution has a pH preferably from 6 to 8, more preferably from 6.5 to 7.5, and still more preferably from 6.8 to 7.2. When the pH of the first mixed solution is greater than 8, calcium hydroxide or calcium carbonate is easily formed in subsequently prepared negative electrode slurry, and then the prepared zinc electrode is hardened, which is not conducive to the winding process of battery cells. In one or more embodiments, the pH of the first mixed solution is adjusted using an organic acid corresponding to the water-soluble calcium salt of organic acid contained therein. When the pH of the first mixed solution is less than 6, the dissolution of the active material zinc oxide and the corrosion of metal zinc are easily caused. In one or more embodiments, the pH of the first mixed solution may alternatively be adjusted using an alkaline solution.

When the zinc electrode is used as a negative electrode of the alkaline nickel-zinc battery, the following electrochemical reactions mainly occur during charge and discharge processes: during charge process, the active material zinc oxide of the zinc electrode obtains electrons and is reduced to metal zinc; and during discharge process, the metal zinc loses electrons and is oxidized to zinc oxide. It needs to be noted that during the electrochemical conversion reactions between zinc oxide and metal zinc, a soluble intermediate product zincate ions Zn(OH)₄²⁻ is easily generated. Furthermore, zinc oxide and metal zinc may interact with alkaline substances such as potassium hydroxide, sodium hydroxide, or lithium hydroxide in the alkaline electrolyte to generate soluble zincate ions. It can be seen therefrom that the zinc negative electrode mainly undergoes the electrochemical mutual conversion reaction between metal zinc and zinc oxide, which are actually the electrochemical deposition of zinc and the dissolution reaction of zinc.

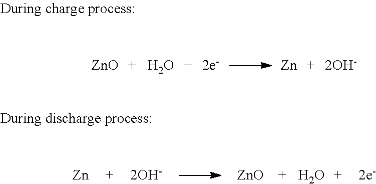

Therefore, the active material of the zinc electrode may include any one form of metal zinc, a zinc compound, and a zinc alloy, in addition to nano-sized zinc oxide. It needs to be noted that a composite material formed by coating the zinc oxide or zinc compounds with carbon can be used as the active material of the zinc electrode. A mercury-free zinc alloy, as a zinc alloy, contains trace elements such as 0.01 wt. % to 0.06 wt. % indium (In), 0.005 wt. % to 0.02 wt. % bismuth (Bi), and 0.0035 wt. % to 0.015 wt. % aluminum (Al), has a superior effect of inhibiting hydrogen evolution reaction, and thus is preferably used. In particular, elements indium (In) and bismuth (Bi) have remarkable effects on improving the charge and discharge performance of the alkaline nickel-zinc battery. Using the mercury-free zinc alloy as the active material of the zinc electrode, the corrosion rate of the zinc electrode in the alkaline electrolyte can be effectively slowed down. In addition, the hydrogen evolution side reaction can be effectively inhibited, avoiding the drying of the electrolyte or the “alkali migration” phenomenon of the alkaline nickel-zinc battery. Thus, the cycle life of the nickel-zinc battery can be prolonged.

In one or more embodiments, the zinc oxide in the active material has an average particle size from 100 nm to 400 nm.

In one or more embodiments, the metal zinc powder in the active material has an average particle size from 10 μm to 200 μm.

In one or more embodiments, the mercury-free zinc alloy has an average particle size from 10 μm to 200 μm.

The water-soluble binder is used to improve the binding property of the active material particles to each other and the binding property of the active material to the current collector. The water-soluble binder may be a rubber-based binder or a polymer resin-based binder. The rubber-based binder may be selected from a group consisting of styrene-butadiene rubber, acrylonitrile-butadiene rubber, acrylic rubber, butyl rubber, fluororubber, and a combination thereof. The polymer resin-based binder may be selected from a group consisting of polytetrafluoroethylene, ethylene propylene copolymer, polyethylene oxide, polyvinylpyrrolidone, polyepichlorohydrin, polyphosphazene, polyacrylonitrile, polystyrene, ethylene propylene diene copolymer, polyvinylpyridine, chlorosulfonated polyethylene, latex, polyester resin, acrylic resin, phenolic resin, epoxy resin, polyvinyl alcohol, and a combination thereof. The thickener may be selected from a group consisting of sodium carboxymethylcellulose, hydroxypropyl methylcellulose, methylcellulose, sodium alginate, β-cyclodextrin, sodium starch phosphate, hydroxypropyl starch, gelatin, xanthan gum, and a combination thereof.

The alkaline solution includes any one or more of a lithium hydroxide solution, a sodium hydroxide solution, and a potassium hydroxide solution. A mass ratio of potassium hydroxide, to sodium hydroxide and to lithium hydroxide is (10 to 30):(1 to 10): 1. A concentration of hydroxide ions is preferably from 6 mol/L to 18 mol/L, more preferably from mol/L 8 to 16 mol/L, and even more preferably from 10 mol/L to 15 mol/L.

Examples of the current collector form may include an open-cell metal, an expansion alloy, a sieve mesh, a twilled weave mesh, a foam, a three-dimensional punched foil, a three-dimensional burr mesh, a perforated foil, and a porous metal. The current collector is preferably made of a metal having high electrical conductivity and strong corrosion resistance, more preferably pure copper and a copper alloy (e.g., brass, phosphorus copper), and most preferably pure copper. In addition, the surface of the current collector has good electrical conductivity. Therefore, it is possible to form a structure in which the surface is made of copper, tin, a copper alloy, or a tin alloy and the interior is made of other materials such as zinc (Zn), aluminum (Al), antimony (Sb), bismuth (Bi), indium (In), and titanium (Ti), with the material for the interior not limited to a metal. The surface of the current collector may be plated with a metal such as zinc (Zn), tin (Sn), indium (In), bismuth (Bi), aluminum (Al), silver (Ag), mercury (Hg), or lead (Pb), and preferably plated with tin. According to such plating, the occurrence of the hydrogen evolution side reaction on the surface of the zinc electrode can be effectively suppressed and the corrosion resistance of the current collector in an alkaline environment can be improved.

It needs to be noted that when an alkaline electrolyte containing potassium hydroxide, sodium hydroxide, and lithium hydroxide is added to a battery cell composed of a zinc negative electrode sheet and a Ni(OH)₂ positive electrode sheet, the negative electrode sheet mainly undergoes the following chemical reactions:

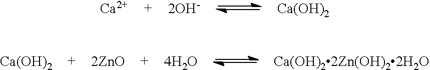

From the thermodynamic point of view, the reactions can proceed spontaneously inside the alkaline nickel-zinc battery. Among them, the surface of the active material (zinc oxide and zinc powder particles) of the zinc electrode will be coated with calcium hydroxide, calcium zincate, and a combination thereof in situ. Furthermore, soluble zincate ions formed during charge and discharge processes can be effectively anchored in a specific area of the zinc electrode by the uniformly distributed calcium element, avoiding the deformation of the zinc electrode and inhibiting the growth of zinc dendrites during charge and discharge processes.

In one or more embodiments, the active material for preparing the slurry may alternatively be carbon-coated zinc oxide nanoparticles, carbon-coated zinc carbonate, carbon-coated calcium zincate, carbon-coated metal zinc, and a combination thereof.

In one or more embodiments, it is also necessary to add functional materials such as a rare earth oxide, a metal oxide additive, a metal hydroxide additive, a binder, a thickener, and a conductive agent when preparing the slurry. Examples of the rare earth oxide may include ceric oxide, yttrium oxide, erbium oxide, dysprosium oxide, samarium oxide, gadolinium oxide, lanthanum trioxide, etc. Examples of the oxide additive may include magnesium oxide, mercuric oxide, lead oxide, barium oxide, aluminum oxide, bismuth oxide, indium oxide, boron oxide, and silica, etc. Examples of the hydroxide additive may include bismuth hydroxide, indium hydroxide, barium hydroxide, magnesium hydroxide, and aluminum hydroxide, etc. Examples of the binder may include polytetrafluoroethylene emulsion, styrene-butadiene rubber emulsion, polyvinyl alcohol, and acrylonitrile multi-component copolymer water-soluble binders etc. Examples of the thickener may include sodium carboxymethylcellulose, hydroxypropyl methylcellulose, methylcellulose, sodium alginate, β-cyclodextrin, sodium starch phosphate, hydroxypropyl starch, gelatin, and xanthan gum, etc. Examples of the conductive agent may include metal tin powder, mercury-free zinc alloy powder, metal copper powder, metal indium powder, metal bismuth powder, metal titanium powder, metal antimony powder, metal tungsten powder, natural graphite, artificial graphite, carbon fibers, graphene, graphene oxide, carbon nanotubes, conductive carbon black, and calcined organic polymer compounds.

In one or more embodiments, the zinc electrode that has been baked at a high temperature is subjected to a rolling treatment to prevent the active material from peeling and to increase the compact density of the zinc electrode.

In one or more embodiments, the zinc electrode is subjected to an edging treatment to remove metal burrs caused by a hardware mold or in a laser slitting process, further avoiding possible short-circuiting between the zinc electrode and the positive electrode.

In one or more embodiments, the zinc electrode is subjected to a kneading softening treatment to improve the softness of the zinc electrode, further improving the permeation and wetting effects of the alkaline electrolyte into the zinc electrode sheet.

In one or more embodiments, the zinc electrode is subjected to tab welding, wherein metal sheets having good conductivity, high alkali resistance, and high hydrogen evolution overpotential, such as copper sheets, zinc sheets, tin-plated copper sheets, and zinc-copper alloys, can be used as tabs, so as to improve electron transport during charge and discharge processes.

It needs to be noted that the zinc electrode provided by the present disclosure can be applied not only to an alkaline zinc-nickel battery, but also to an alkaline silver-zinc secondary battery, an alkaline zinc-manganese secondary battery, and the like.

Compared with the prior art, the present disclosure has the following beneficial effects:
1. The zinc electrode prepared by the preparation method provided by the present disclosure can significantly improve the performance of the alkaline nickel-zinc battery, especially increase the utilization rate of the active material zinc oxide and the capacity retention in the cycle process.
2. The preparation method provided by the present disclosure can effectively improve the wettability of the zinc electrode towards the alkaline electrolyte. This mainly involves soluble calcium ions in the zinc electrode interacting with hydroxide ions in the alkaline electrolyte, which is conducive to promoting the hydroxide ions to rapidly penetrate into and wet the zinc electrode during charge and discharge processes.
3. The water-soluble calcium salt of organic acid provided in the present disclosure has higher solubility, which is conducive to the uniform distribution of calcium element in the zinc electrode. Thus, the utilization rate of calcium atoms is effectively increased, and the anchoring effects between the calcium element and the zinc oxide nanoparticles as well as the intermediate products of charge and discharge are further strengthened. Since the electrodeposition and dissolution reactions of zinc occur in a specific area, the deformation of the zinc electrode can be minimized, even the growth of zinc dendrites can be reduced, and the cycle life of the alkaline nickel-zinc battery can be prolonged.
4. The preparation method provided by the present disclosure can be implemented with the existing preparation equipment for electrode sheets. Due to the mild nature of the negative electrode slurry, it is not strongly alkaline and corrosive. Not only can the “hardening” of the zinc electrode sheets caused by calcium hydroxide or calcium carbonate generated in the preparation process be avoided, but also can the introduction of impurity elements such as iron, nickel, and manganese in the equipment into the zinc electrode be effectively avoided, which otherwise affects the performance of the alkaline nickel-zinc battery.

The following description will be made in conjunction with specific Examples.

### BRIEF DESCRIPTION OF THE DRAWINGS

The drawings are used for further interpreting the present disclosure, but the Examples in the drawings do not constitute any limitation to the present disclosure. In the drawings:

FIG. 1 shows test results of microstructure by means of FE-SEM and element distribution by means of EDS analysis of the surface of a zinc electrode provided in Example 1 of the present disclosure (FIG. 1a shows the microstructure by means of FE-SEM; FIG. 1b shows the Zn element distribution; FIG. 1c shows the O element distribution; FIG. 1d shows the C element distribution; and FIG. 1e shows the Ca element distribution);

FIG. 2 shows test results of microstructure by means of FE-SEM and element distribution by means of EDS analysis of the surface of a zinc electrode provided in Example 2 of the present disclosure (FIG. 2a shows the microstructure by means of FE-SEM; FIG. 2b shows the Zn element distribution; FIG. 2c shows the O element distribution; FIG. 2d shows the C element distribution; and FIG. 2e shows the Ca element distribution);

FIG. 3 shows test results of microstructure by means of FE-SEM and element distribution by means of EDS analysis of the surface of a zinc electrode provided in Example 3 of the present disclosure (FIG. 3a shows the microstructure by means of FE-SEM; FIG. 3b shows the Zn element distribution; FIG. 3c shows the O element distribution; FIG. 3d shows the C element distribution; and FIG. 3e shows the Ca element distribution);

FIG. 4 shows contact angle test results of zinc electrodes (FIG. 4a shows the zinc electrode provided in Example 3 of the present disclosure; and FIG. 4b shows the zinc electrode provided in Comparative Example 1 of the present disclosure);

FIG. 5 shows performance test results of a button cell CR2032 prepared using the zinc electrode provided in Example 1 of the present disclosure (FIG. 5a shows cycle performance data; FIG. 5b shows discharge plateau data; and FIG. 5c shows charge/discharge curves of the first five cycles);

FIG. 6 shows performance test results of a button cell CR2032 prepared using the zinc electrode provided in Example 2 of the present disclosure (FIG. 6a shows cycle performance data; FIG. 6b shows discharge plateau data; and FIG. 6c shows charge/discharge curves of the first five cycles);

FIG. 7 shows performance test results of a button cell CR2032 prepared using the zinc electrode provided in Example 3 of the present disclosure (FIG. 7a shows cycle performance data; FIG. 7b shows discharge plateau data; and FIG. 7c shows charge/discharge curves of the first five cycles);

FIG. 8 shows performance test results of a button cell CR2032 prepared using the zinc electrode provided in Comparative Example 1 of the present disclosure (FIG. 8a shows cycle performance data; FIG. 8b shows discharge plateau data; and FIG. 8c shows charge/discharge curves of the first five cycles).

### DETAILED DESCRIPTION OF THE EMBODIMENTS

It should be understood that the specific Examples described herein are merely intended to explain the present disclosure, rather than to limit the present disclosure.

Zinc electrodes provided by the Examples of the present disclosure can be applied to alkaline nickel-zinc batteries as negative electrodes of the alkaline nickel-zinc batteries.

### [Alkaline Nickel-Zinc Battery]

The alkaline nickel-zinc battery includes a closed container which has a positive electrode, an electrolyte, a negative electrode, and a separator therein.

### [Positive Electrode]

The positive electrode includes a positive electrode active material including nickel hydroxide and/or nickel oxide hydroxide, and a positive electrode current collector. Nickel hydroxide is usually presented in the form of spherical particles, and a doping element other than nickel can be solid-solved in its crystal lattices, which is conducive to improving the cycle performance of the alkaline nickel-zinc battery and providing higher coulombic efficiency at a high temperature. Examples of the doping element may include elements such as zinc (Zn), cobalt (Co), aluminum (Al), magnesium (Mg), tungsten (W), titanium (Ti), barium (Ba), and zirconium (Zr). A cobalt-based compound can be directly added to the active material nickel hydroxide for use, and examples of such cobalt-based compound may include metal cobalt powder, cobaltous oxide, cobaltic oxide, cobaltosic oxide, and any combination thereof. In addition, a cobalt-based compound may be used to coat the surface of spherical particles of nickel hydroxide, particularly a positive electrode material in which a doping element is solid-solved. Examples of such cobalt-based compounds may include cobaltous oxide, α-cobalt hydroxide, β-cobalt hydroxide, compounds of high-valence cobalt exceeding divalence, and any combination thereof.

The positive electrode active material may further contain an additional element in addition to the nickel hydroxide-based compounds and the doping elements solid-solved in the nickel hydroxide-based compounds. Examples of such additional element may include scandium (Sc), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), lutetium (Lu), hafnium (Hf), tantalum (Ta), tungsten (W), rhenium (Re), osmium (Os), iridium (Ir), platinum (Pt), gold (Au), mercury (Hg), and any combination thereof. The form of the additional element is not particularly limited, and it may be present in the form of a metal elemental substance or a metal compound (e.g., an oxide, a hydroxide, a nitride, a sulfide, a carbide, a halide, and a carbonate). An addition amount of the metal elemental substance or the metal compound as the additional element is preferably from 0.5 to 20 parts by weight, and more preferably from 1 to 5 parts by weight, relative to 100 parts by weight of the nickel hydroxide-based compound.

The positive electrode may contain a conductive material, a binder, and a thickener as needed. Examples of the conductive material may include graphite, graphene, graphene oxide, carbon black, metal nickel powder, metal tungsten powder, metal cobalt powder, and the like. Examples of the binder and the thickener may include polyvinylidene fluoride, polyvinyl alcohol, hydroxypropyl methylcellulose, sodium carboxymethylcellulose, sodium polyacrylate, polystyrene butadiene copolymer, polytetrafluoroethylene, and the like.

The positive electrode may alternatively be prepared by a dry process or a wet process as needed, and the positive electrode active material, the conductive agent, the binder, and the like may be sufficiently premixed during the preparation process.

Preferable examples of the positive electrode current collector may include a porous substrate made of nickel such as a foamed nickel plate. In this case, for example, it is preferred to prepare the positive electrode formed of the positive electrode active material and the positive electrode current collector by uniformly applying a positive electrode slurry containing an active material such as nickel hydroxide to the porous substrate made of nickel and drying it. In this case, it is also preferred to subject the dried positive electrode to a rolling treatment, so as to prevent the positive electrode active material from peeling and to increase the compact density of the electrode. It is also preferred to subject the dried positive electrode to an edging treatment, so as to reduce the risk of short circuiting of the battery by removing possible metal burrs. It is also preferred to subject the dried positive electrode to a kneading treatment. By improving the flexibility of the positive electrode sheet, not only can the breakage of the electrode sheet during the winding process of the battery cell be avoided, but also can the rapid permeation of the alkaline electrolyte into the positive electrode sheet be facilitated.

### [Electrolyte]

The electrolyte contains an alkali metal hydroxide. An aqueous solution containing the alkali metal hydroxide is used as the electrolyte of the alkaline nickel-zinc battery. Examples of the alkali metal hydroxide may include potassium hydroxide, sodium hydroxide, lithium hydroxide, and the like. A mass ratio of potassium hydroxide, to sodium hydroxide and to lithium hydroxide is (10 to 30):(1 to 10): 1. In order to reduce the corrosion of zinc in an alkaline environment, compounds such as zinc oxide, zinc hydroxide, fumed silica, and aluminum hydroxide may be added to the alkaline electrolyte. In order to suppress the gas evolution during charge and discharge processes, a trace amount of a compound of indium (In), bismuth (Bi), tin (Sn), lead (Pb), magnesium (Mg), barium (Ba), calcium (Ca), aluminum (Al), mercury (Hg), or lead (Pb) may be added to the alkaline electrolyte, e.g., a hydroxide, a sulfide, a halide, a nitrate, a nitrite, a sulfate, a phosphate, a pyrophosphate, a polyphosphate, or any combination thereof. In order to suppress the deformation of the zinc negative electrode, a soluble calcium salt of organic acid, zinc oxide, or calcium hydroxide may be added to the alkaline electrolyte. Examples of the soluble calcium salt of organic acid may include at least one of calcium lactate, calcium acetate, calcium L-threonate, calcium gluconate, calcium benzoate, calcium glycerophosphate, calcium formate, calcium fumarate, calcium aspartate, calcium malate, calcium maleate, calcium propionate, calcium methanesulfonate, calcium triflate, calcium mellitate, and calcium p-toluenesulfonate.

A concentration of the alkali metal hydroxide in the electrolyte is preferably from 6 mol/L to 18 mol/L, more preferably from 8 mol/L to 16 mol/L, and even more preferably from 10 mol/L to 15 mol/L. A higher concentration of hydroxide ions in the alkaline electrolyte can not only improve the ionic conductance of the electrolyte, reduce the internal resistance of the alkaline nickel-zinc battery, and improve the C-rate performance of the alkaline nickel-zinc battery, but also promote the soluble calcium salt of organic acid to participate in the reaction of in-situ coating on the surface of the active material, effectively inhibit the deformation of the zinc electrode, and prolong the cycle life of the alkaline nickel-zinc battery.

### [Separator]

The separator is a member that is interposed between the nickel hydroxide positive electrode and the zinc negative electrode, maintains insulation between the positive electrode and the negative electrode, and is capable of conducting hydroxide ions. As the separator, for example, a porous film made of resin, a nonwoven fabric made of resin, or the like may be used. Examples of the resin may include polyolefin, fluorine-based polymers, cellulose-based polymers, polyimide, nylon, and the like. The separator may have a single-layer structure or a stacked structure of two or more layers. For example, a three-layer composite structure in which polypropylene (PP) plastic layers are stacked on both sides of a polyethylene (PE) plastic layer. The compositing may be performed by using water-soluble glue or a hot-pressing technique. The separator of the alkaline nickel-zinc battery has strong electrolyte absorption capacity, and can solve the short-circuiting problem caused by zinc dendrites. In order to further improve the hydrophilicity and solution absorption performance of the separator, the surface of the non-woven fabric separator may be grafted or sulfonated. In order to avoid the short circuit caused by zinc dendrites, the pore size range of the separator needs to be controlled to be from 10 nm to 80 nm. In addition, a separator formed by coating a porous substrate with an oxide such as zinc oxide, silicon dioxide, alumina, titanium dioxide, or magnesium oxide, and/or a nitride such as aluminum nitride, silicon nitride, or boron nitride may be used as the separator, so as to improve the thermal stability of the separator.

### Example 1

This Example provided a zinc electrode. A preparation method therefor included the following steps.
In step 1, calcium lactate was dissolved in deionized water to obtain a first mixed solution. A content of calcium ions in the first mixed solution was 0.1 mol/L.
In step 2, the first mixed solution, carbon-coated zinc oxide particles (average particle size: 100-400 nm), zinc powder particles, styrene-butadiene rubber, and sodium carboxymethylcellulose were mixed, and thoroughly stirred in a general-purpose mixer to obtain a uniformly dispersed negative electrode slurry. In the negative electrode slurry, a mass ratio of the calcium lactate, to the carbon-coated zinc oxide particles, to the zinc powder particles, to the styrene-butadiene rubber, and to the sodium carboxymethylcellulose was 1:90:7:1:1.
In step 3, a tin-plated copper foil with a thickness of 25 μm was used as a current collector. According to a conventional method, the negative electrode slurry was uniformly applied to the surface of the current collector in an amount of 10 mg/cm², and then subjected to high-temperature baking at 160° C. in vacuum for 30 minutes.
In step 4, the dried electrode sheet was subjected to a rolling treatment with a rolling tonnage of 35 T to obtain the zinc electrode.

### Example 2

This Example provided a zinc electrode. A preparation method therefor included the following steps.
In step 1, calcium L-threonate was dissolved in deionized water to obtain a first mixed solution. A content of the calcium L-threonate in the first mixed solution was 0.05 mol/L.
In step 2, the first mixed solution, carbon-coated zinc oxide particles (average particle size: 100-400 nm), zinc powder particles, styrene-butadiene rubber, and sodium carboxymethylcellulose were mixed, and thoroughly stirred in a general-purpose mixer to obtain a uniformly dispersed negative electrode slurry. In the negative electrode slurry, a mass ratio of the calcium L-threonate, to the carbon-coated zinc oxide particles, to the zinc powder particles, to the styrene-butadiene rubber, and to the sodium carboxymethylcellulose was 1:90:7:1:1.
In step 3, a tin-plated copper foil with a thickness of 25 μm was used as a current collector. According to a conventional method, the negative electrode slurry was uniformly applied to the surface of the current collector in an amount of 8 mg/cm², and then subjected to high-temperature baking at 150° C. in vacuum for 1 hour.
In step 4, the dried electrode sheet was subjected to a rolling treatment with a rolling tonnage of 35 T to obtain the zinc electrode.

### Example 3

This Example provided a zinc electrode. A preparation method therefor included the following steps.
In step 1, calcium acetate was dissolved in deionized water to obtain a first mixed solution. A content of the calcium acetate in the first mixed solution was 0.1 mol/L.
In step 2, the first mixed solution, carbon-coated zinc oxide particles (average particle size: 100-400 nm), zinc powder particles, styrene-butadiene rubber, and sodium carboxymethylcellulose were mixed, and thoroughly stirred in a general-purpose mixer to obtain a uniformly dispersed negative electrode slurry. In the negative electrode slurry, a mass ratio of the calcium acetate, to the carbon-coated zinc oxide particles, to the zinc powder particles, to the styrene-butadiene rubber, and to the sodium carboxymethylcellulose was 1:87:10:1:1.
In step 3, a tin-plated copper foil with a thickness of 20 μm was used as a current collector. According to a conventional method, the negative electrode slurry was uniformly applied to the surface of the current collector in an amount of 12 mg/cm², and then subjected to high-temperature baking at 180° C. in vacuum for 30 minutes.
In step 4, the dried electrode sheet was subjected to a rolling treatment with a rolling tonnage of 35 T to obtain the zinc electrode.

### Comparative Example 1

This Comparative Example differed from Example 1 only in that no calcium lactate was used to prepare the zinc electrode.
In step 1, carbon-coated zinc oxide particles (average particle size: 100-400 nm), zinc powder particles, styrene-butadiene rubber, and sodium carboxymethylcellulose were mixed in a mass ratio of 90:8:1:1, and thoroughly stirred in a general-purpose mixer to obtain a uniformly dispersed negative electrode slurry.
In step 2, a tin-plated copper foil with a thickness of 25 μm was used as a current collector. According to a conventional method, the negative electrode slurry was uniformly applied to the surface of the current collector in an amount of 10 mg/cm², and then subjected to high-temperature baking at 160° C. in vacuum for 30 minutes.
In step 3, the dried electrode sheet was subjected to a rolling treatment with a rolling tonnage of 35 T to obtain the zinc electrode.

### Comparative Example 2

The Comparative Example provided a zinc electrode. A preparation method therefor included the following steps.
In step 1, calcium hydroxide and deionized water were mixed to obtain a first suspension, with each 1 L of deionized water corresponding to 7.41 g of calcium hydroxide.
In step 2, the first mixed suspension, carbon-coated zinc oxide particles (average particle size: 100-400 nm), zinc powder particles, styrene-butadiene rubber, and sodium carboxymethylcellulose were mixed, and thoroughly stirred in a general-purpose mixer to obtain a uniformly dispersed negative electrode slurry. In the negative electrode slurry, a mass ratio of the calcium hydroxide, to the carbon-coated zinc oxide particles, to the zinc powder particles, to the styrene-butadiene rubber, and to the sodium carboxymethylcellulose was 1:90:7:1:1.
In step 3, a tin-plated copper foil with a thickness of 25 μm was used as a current collector. According to a conventional method, the negative electrode slurry was uniformly applied to the surface of the current collector in an amount of 10 mg/cm², and then subjected to high-temperature baking at 150° C. in vacuum for 1 hour.
In step 4, the dried electrode sheet was subjected to a rolling treatment with a rolling tonnage of 35 T to obtain the zinc electrode.

### Comparative Example 3

The Comparative Example provided a zinc electrode. A preparation method therefor included the following steps.
In step 1, acetic acid was dissolved in deionized water to obtain a first mixed solution. A content of acetic acid in the first mixed solution was 0.1 mol/L.
In step 2, the first mixed solution, carbon-coated zinc oxide particles (average particle size: 100-400 nm), zinc powder particles, styrene-butadiene rubber, and sodium carboxymethylcellulose were mixed, and thoroughly stirred in a general-purpose mixer to obtain a uniformly dispersed negative electrode slurry, wherein a mass ratio of the acetic acid, to the carbon-coated zinc oxide particles, to the zinc powder particles, to the styrene-butadiene rubber, and to the sodium carboxymethylcellulose was 1:87:10:1:1.
In step 3, a 0.5 mol/L of sodium hydroxide solution was used to adjust the pH of the negative electrode slurry to 7.2, and a tin-plated copper foil with a thickness of 10 μm was used as a current collector. According to a conventional method, the negative electrode slurry was applied to the surface of the copper foil in an amount of 22 mg/cm², and then subjected to high-temperature baking at 140° C. in vacuum for 10 hours.
In step 4, the dried electrode sheet was subjected to a rolling treatment with a rolling tonnage of 35 T to obtain the zinc electrode.

### Comparative Example 4

The Comparative Example provided a zinc electrode. A preparation method therefor included the following steps.
In step 1, calcium hydroxide particles and zinc oxide particles with an average particle size from 100 nm to 400 nm were put into a mill pot of a planetary ball mill.
In step 2, stainless steel balls were added to the mill pot in a mass ratio of balls to materials of 4:1, and then deionized water was added for ball milling at a rotating speed of 300 revolutions per minute under argon protection. The product was taken out after the ball milling for 15 hours, and baked at 50° C. for 12 hours to obtain a first mixture.
In step 3, deionized water, the first mixture, zinc powder particles, styrene-butadiene rubber, and sodium carboxymethylcellulose were thoroughly stirred in a general-purpose mixer, to obtain uniformly dispersed negative electrode slurry. In the negative electrode slurry, a mass ratio of the calcium hydroxide, to the zinc oxide particles, to the zinc powder particles, to the styrene-butadiene rubber, and to the sodium carboxymethylcellulose was 1:90:7:1:1, and a 0.5 mol/L of sodium hydroxide solution was used to adjust the pH of the slurry to 7.2.
In step 4, a tin-plated copper foil with a thickness of 10 μm was used as a current collector. According to a conventional method, the slurry was applied to the surface of the copper foil in an amount of 22 mg/cm², and then subjected to high-temperature baking at 140° C. in vacuum for 10 hours to obtain the zinc electrode.

### [Comparative Test]

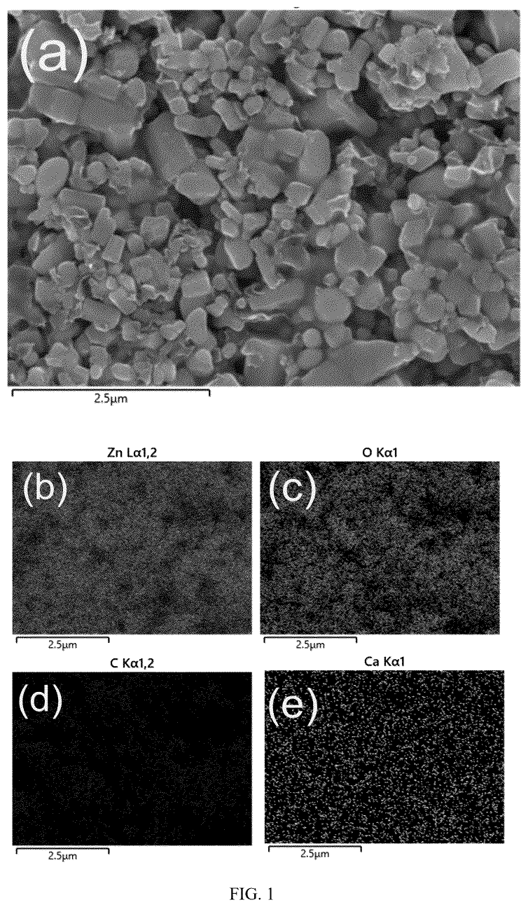

The zinc electrodes prepared in Examples 1 to 3 were subjected to observation by means of field emission scanning electron microscope (FE-SEM), and the observed areas were tested for element distribution using an X-ray energy dispersive spectroscopy (EDS) device. Results as shown in FIG. 1 to FIG. 3 showed that the calcium element distribution of the zinc electrodes prepared by the preparation methods of Examples 1 to 3 was well uniform. The uniformly distributed calcium element was conducive to reducing the solubility of zinc oxide in the alkaline electrolyte, inhibiting the diffusion of zincate ions in the electrolyte, improving the deformation of the zinc electrode, and inhibiting the growth of zinc dendrites. In addition, the evenly distributed calcium element was conducive to effectively anchoring zincate ions formed during charge and discharge processes of the alkaline nickel-zinc battery and forming relatively insoluble phase calcium zincate on the surface of the zinc electrode or in a specific area therein, thereby realizing an improvement on the cycle performance of the alkaline nickel-zinc battery.

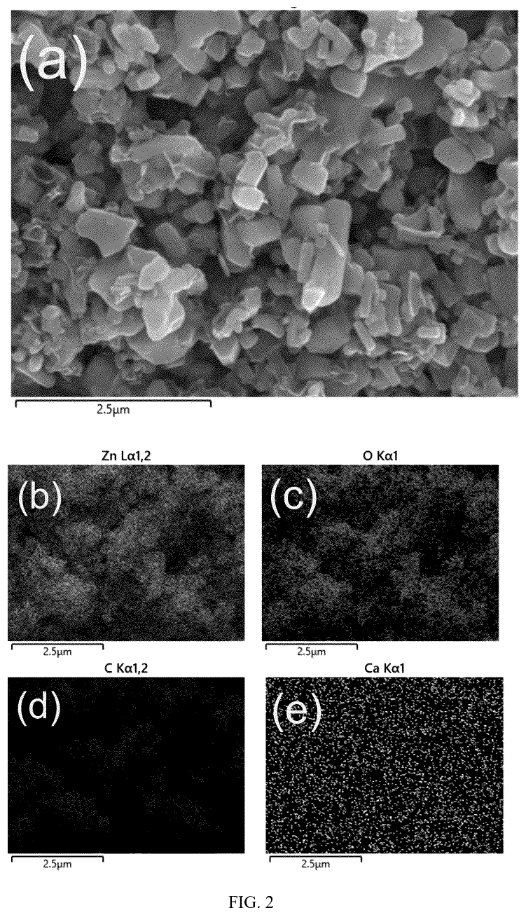

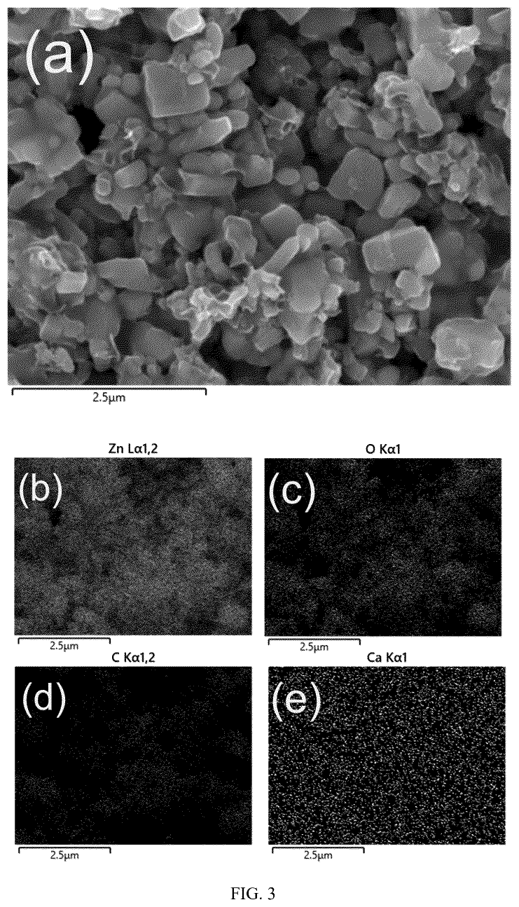

It needs to be noted that as shown in FIG. 1a, FIG. 2a, and FIG. 2c, microstructure test results of the surface of the zinc electrode by means of FE-SEM showed that the zinc negative electrode was mainly composed of 100-400 nm carbon-coated nano-sized zinc oxide particles. Furthermore, by the element distribution test by means of EDS analysis, the uniform distribution of elements Zn, O, C, and Ca could be seen clearly. As shown in FIG. 1b, FIG. 2b, and FIG. 3b, the element Zn was uniformly distributed and was mainly from the active material zinc oxide or metal zinc. As shown in FIG. 1c, FIG. 2c, and FIG. 3c, the element O was uniformly distributed and was mainly from the active material zinc oxide. As shown in FIG. 1d, FIG. 2d, and FIG. 3d, the element C was uniformly distributed and was mainly from the carbon coating layer, the water-soluble binder, and the thickener. As shown in FIG. 1e, FIG. 2e, and FIG. 3e, the element Ca was uniformly distributed and was mainly from the soluble calcium salt of organic acid. If an insoluble inorganic calcium salt was used, the distribution of the element Ca was relatively concentrated, which was mainly affected by its particle size and solubility. The uniform distribution of the element Ca in the zinc electrodes prepared in Examples 1 to 3 of the present disclosure was mainly related to its existence in the form of calcium ion in the negative electrode slurry.

The zinc electrodes prepared in Examples 1 to 3 and the zinc electrodes prepared in Comparative Examples 1 to 4 were subjected to a contact angle test with respect to the alkaline electrolyte. The contact angle test was carried out in an environment at a temperature of 20° C. to 25° C. and with a humidity≤50% RH. 1 μL alkaline electrolyte was added dropwise onto the surface of the zinc electrode by using a plastic dropper. A smaller included angle between the test liquid surface and the zinc electrode indicated more complete wetting of the alkaline electrolyte. Better wettability of the zinc electrode towards the alkaline electrolyte was more conducive to improving the performance of the alkaline nickel-zinc battery. The contact angle test results were as shown in Table 1.

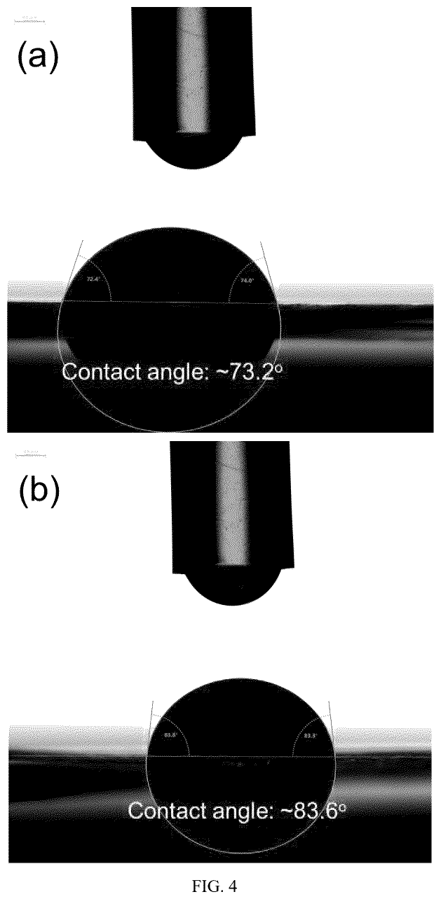

It needs to be noted that the soluble calcium salt of organic acid could greatly improve the wettability of the zinc electrode towards the alkaline electrolyte. As shown in FIG. 4, by comparing Example 3 (FIG. 4a) and Comparative Example 1 (FIG. 4b), when the soluble calcium salt of organic acid (calcium acetate) was added, the contact angle between the zinc electrode and the alkaline electrolyte was 73.2°, which was significantly lower than that (83.6°) of the zinc electrode without the addition of the calcium salt of organic acid. This was mainly related to the uniform distribution of the soluble calcium salt of organic acid in the zinc electrode. The calcium ions in the soluble calcium salt of organic acid could chemically react with the hydroxide ions in the alkaline electrolyte, so that calcium hydroxide or calcium zincate could be generated in situ inside the alkaline nickel-zinc battery to coat the surface of the active materials zinc oxide and zinc powder. This could not only promote the permeation of the alkaline electrolyte into interior of the zinc negative electrode, but also reduce the solubility of zinc oxide in the alkaline electrolyte and solve the problem of random diffusion of zincate ions generated during charge and discharge processes in the alkaline electrolyte.

### [Manufacturing Method for Alkaline Nickel-Zinc Battery]

The zinc electrodes prepared in Examples 1 to 3 and the zinc electrodes prepared in Comparative Examples 1 to 4 were used to prepare alkaline nickel-zinc batteries, respectively, and the specific preparation method was as follows.
In step 1, a positive electrode steel shell and a negative electrode steel shell of a standard button cell CR2032 were prepared using an iron substrate with nickel plating and tin plating on the surface thereof, respectively, by means of a method of drawing metal plate.
In step 2, foamed nickel was used as a positive electrode current collector, and the foamed nickel was filled with a positive electrode active material, a conductive agent, and a binder to prepare a positive electrode. The positive electrode mainly included nickel hydroxide, metal nickel, yttrium oxide, polytetrafluoroethylene, and carboxymethylcellulose. A mass ratio of the nickel hydroxide, to the metal nickel, to the yttrium oxide, to the polytetrafluoroethylene, and to the carboxymethylcellulose was 92:2:2:2:2. In addition, the positive electrode was coated in an amount of about 200 mg/cm², and had a thickness of about 300 μm and a diameter of 15 mm.
In step 3, the zinc electrodes prepared in Examples 1 to 3 and Comparative Examples 1-4 were cut into zinc electrode sheets having a diameter of 14 mm, respectively.
In step 4, a composite hydrophilic separator with a thickness of about 120 μm and a diameter of about 16 mm was used. Wherein, a thickness of a non-woven fabric with strong solution absorption capability was about 100 μm, and a thickness of a microporous separator with anti-dendrite function was about 20 μm. The composite hydrophilic separator was interposed between the positive electrode and the zinc electrode sheet by sequentially stacking the positive electrode, the separator, and the zinc electrode sheet, which was then injected with an electrolyte and sealed, and was stored in a standard button cell CR2032 container. For the alkaline electrolyte, a concentration of hydroxide ions was about 12 mol/L.

The resulting alkaline nickel-zinc button cell was subjected to the following performance test.

### [Charge-Discharge Cycle Test]

The alkaline nickel-zinc button cell was subjected to the following charge-discharge cycle test using a Neware battery testing system.

As a first charge-discharge cycle, the resulting alkaline nickel-zinc button cell was charged to 1.9 V with a constant current value of 1/10 C, and then charged at a constant voltage of 1.9 V to 0.1 C. Finally, the alkaline nickel-zinc button cell after being charged was subjected to constant current discharge at a current value of ½ C to 1.2 V.

Next, as a second charge-discharge cycle, the resulting alkaline nickel-zinc button cell was charged to 1.9 V with a constant current value of ⅕ C, and then charged at a constant voltage of 1.9 V to 0.1 C. Finally, the alkaline nickel-zinc button cell after being charged was subjected to constant current discharge at a current value of ½ C to 1.2 V.

Thereafter, as a third charge-discharge cycle, the resulting alkaline nickel-zinc button cell was charged to 1.9 V with a constant current value of ½ C, and then charged at a constant voltage of 1.9 V to 0.1 C. Finally, the alkaline nickel-zinc button cell after being charged was subjected to constant current discharge at a current value of ½ C to 1.2 V.

Thereafter, the third charge-discharge procedure was repeated to perform charge-discharge cycles with a maximum of 100 cycles.

A capacity retention (%) was calculated with the values of the discharge capacity per gram at the first charge-discharge cycle and the discharge capacity per gram at a predetermined cycle number. Moreover, according to the theoretical discharge capacity per gram of 658 mAh/g of zinc oxide, the utilization rate of the active material zinc oxide in the alkaline nickel-zinc battery could be calculated by dividing the actual discharge capacity per gram of the zinc oxide by the theoretical capacity per gram 658 mAh/g of the zinc oxide. The results were as shown in Table 1.

According to the results shown in Table 1, the zinc electrodes provided in Examples 1 to 3 of the present disclosure exhibited better initial discharge capacity per gram, higher zinc oxide utilization rate, and higher capacity retention than those provided in the Comparative Examples of the present disclosure. By adding the soluble calcium salt of organic acid to the zinc electrode, not only was the dissolution problem of the active material zinc oxide in the alkaline electrolyte overcome, but also could the random diffusion of the intermediate product zincate ions formed during charge and discharge processes be effectively inhibited. By improving the deformation of the zinc electrode and inhibiting the growth of zinc dendrites, the cycle stability of the alkaline nickel-zinc battery and the utilization rate of the active material were significantly improved.

Moreover, the soluble calcium salt of organic acid was conducive to the permeation and wetting of the alkaline electrolyte. The wetting angles of the electrolyte on the zinc electrodes provided in Examples 1 to 3 of the present disclosure were significantly smaller than those of the Comparative Examples provided in the present disclosure. Excellent electrolyte wettability was conducive to increasing the utilization rate of the active material zinc oxide. Generally speaking, zinc oxide, as an important active material in the negative electrode of the alkaline nickel-zinc battery, has the theoretical capacity per gram of 658 mAh/g. The utilization rate of the active material in the existing alkaline nickel-zinc battery is only 20% to 30%. Therefore, during the design process of an alkaline nickel-zinc battery, the amount of the negative active material needs to be much higher than its theoretical design value, and the theoretical capacity of the negative electrode can even reach twice or more of the capacity of the positive electrode. In Comparative Example 1 of the present disclosure, carbon-coated zinc oxide was used, and the utilization rate of the active material could be increased to 64%. By adding the soluble calcium salt of organic acid to the zinc electrodes, the zinc electrodes provided in Examples 1 to 3 of the present disclosure could exhibit a utilization rate of active material of 73% to 88% during charge and discharge processes, which was conducive to further improving the gravimetric energy density of the battery.

It needs to be noted that, after 100 charge-discharge cycles, the capacity retention results of the zinc electrodes provided in Examples 1 to 3 of the present disclosure were significantly better than those of the zinc electrodes provided in the Comparative Examples of the present disclosure. In particular, in Example 3 of the present disclosure, the discharge capacity per gram of the zinc electrode remained substantially stable after 100 cycles. By restricting the activity of soluble zincate ions in a specific area, the zincate ions were prevented from randomly diffusing to the alkaline electrolyte, the separator, and even the surface of the positive electrode. The zinc electrodes provided in Examples 1 to 3 of the present disclosure could achieve high capacity retention by alleviating the losses of the active material zinc oxide in the zinc electrodes.

TABLE 1

| | Example | Example | Example | Comparative | Comparative | Comparative | Comparative |
|---|---|---|---|---|---|---|---|
| | 1 | 2 | 3 | Example 1 | Example 2 | Example 3 | Example 4 |
| Wetting angle of | 71.9° | 73.2° | 72.3° | 83.6° | 80.6° | 83.8° | 79.9° |
| electrolyte | | | | | | | |
| Initial discharge | 481 | 513 | 582 | 422 | 454 | 415 | 447 |
| capacity per | | | | | | | |
| gram (mAh/g) | | | | | | | |
| Utilization rate | 73% | 78% | 88% | 64% | 69% | 63% | 68% |
| of ZnO | | | | | | | |
| Capacity retention | 94% | 82% | About | 80% | 81% | 80% | 82% |
| after 100 charge- | | | 100% | | | | |
| discharge cycles | | | | | | | |

In order to further illustrate the effects of the soluble calcium salt of organic acid, the resulting alkaline nickel-zinc button cell CR2032 was subjected to cycle test by using the Neware battery testing system.

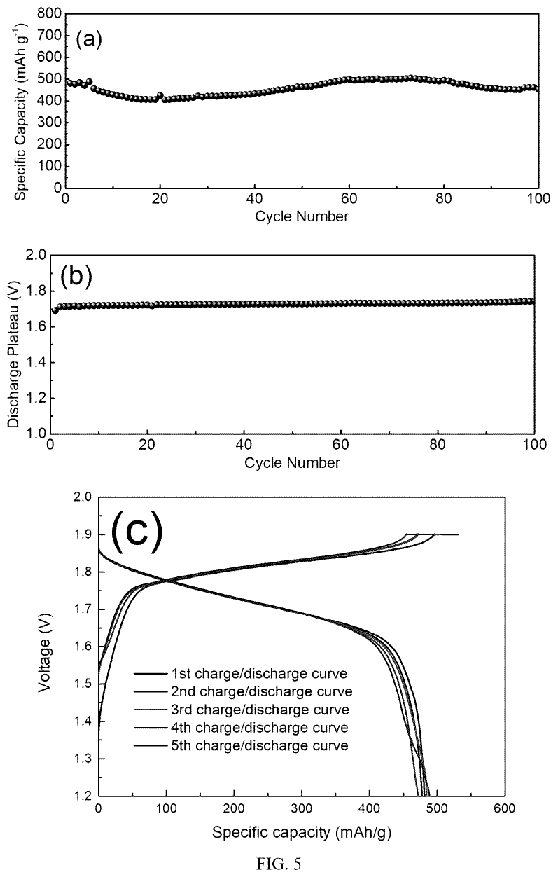

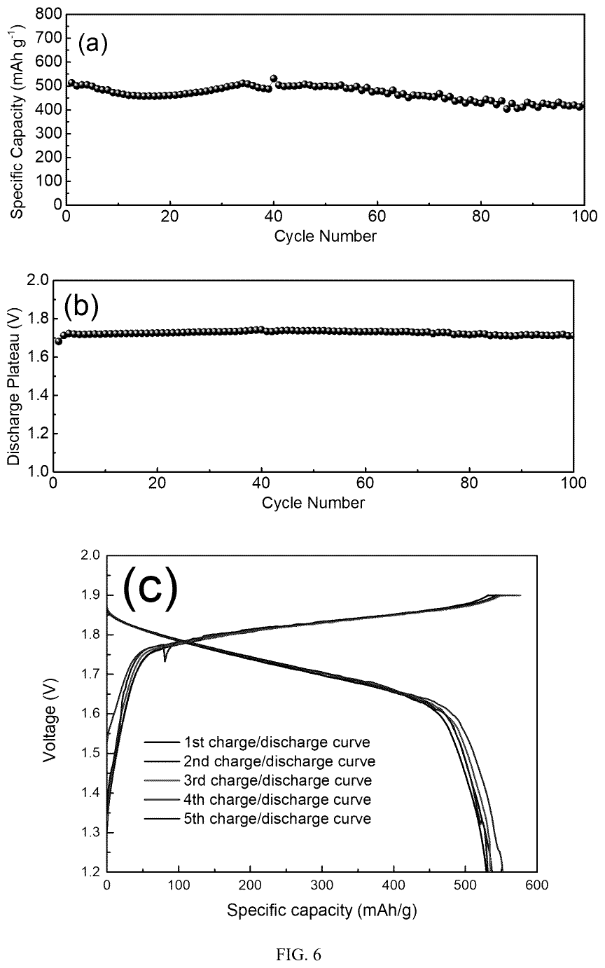

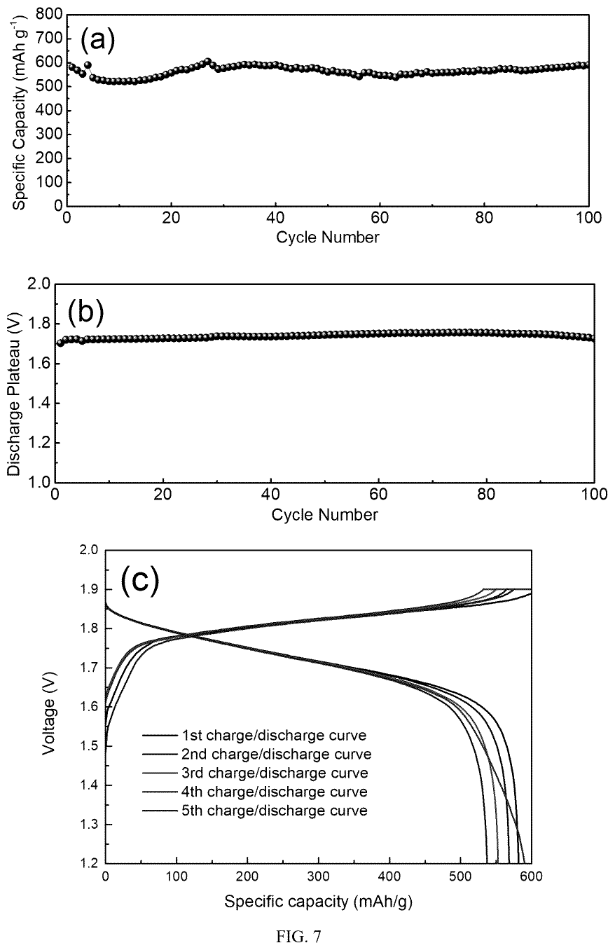

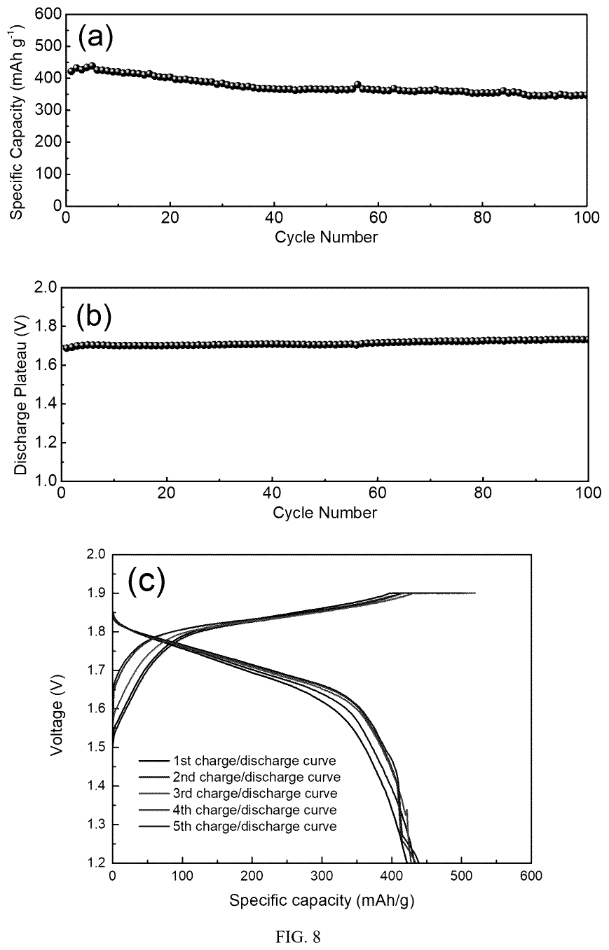

Regarding the discharge capacity per gram of the active material zinc oxide, as shown in FIG. 5a, FIG. 6a, FIG. 7a, and FIG. 8a, the zinc electrodes provided in Examples 1 to 3 and Comparative Example 1 of the present disclosure were subjected to 100 charge-discharge cycles in the nickel-zinc button cell CR2032. The discharge capacity per gram of the zinc electrode provided in Example 1 of the present disclosure was 481 mAh/g at the first cycle, and was 454 mAh/g after 100 charge-discharge cycles, indicating that the capacity retention was 94%. The discharge capacity per gram of the zinc electrode provided in Example 2 of the present disclosure was 513 mAh/g at the first cycle, and was 423 mAh/g after 100 charge-discharge cycles, indicating that the capacity retention was 82%. The discharge capacity per gram of the zinc electrode provided in Example 3 of the present disclosure was 582 mAh/g at the first cycle, and was 591 mAh/g after 100 charge-discharge cycles, indicating that there was no obvious decline in the discharge capacity per gram. However, the discharge capacity per gram of the zinc electrode provided in Comparative Example 1 of the present disclosure was 422 mAh/g at the first cycle, and was 338 mAh/g after 100 charge-discharge cycles, indicating that the capacity retention was 80%.

For a discharge plateau, as shown in FIG. 5b, FIG. 6b, FIG. 7b, and FIG. 8b, after the zinc electrodes provided in Examples 1 to 3 and Comparative Example 1 of the present disclosure were subjected to 100 charge-discharge cycles in the nickel-zinc button cell CR2032, the discharge plateau was generally maintained at about 1.7 V. Generally, zinc electrode prepared from pure zinc oxide could exhibit a discharge plateau from 1.60 V to 1.65 V. The zinc electrodes provided in Examples 1 to 3 and Comparative Example 1 of the present disclosure were prepared with the active material carbon-coated zinc oxide and could exhibit a higher discharge plateau, which was conducive to improving the gravimetric energy density of the alkaline nickel-zinc battery. It can be seen therefrom that the soluble calcium salt of organic acid had no effect on the discharge plateau of the alkaline nickel-zinc battery.

As for the charge/discharge curves, as shown in FIG. 5c, FIG. 6c, FIG. 7c, and FIG. 8c, the charge/discharge curves of the first five cycles of the zinc electrodes provided in Examples 1 to 3 and Comparative Example 1 of the present disclosure in the nickel-zinc button cell CR2032 substantially overlapped, indicating superior electrochemical reversibility and charge-discharge stability. It needs to be noted that there was a slight increase in the initial discharge capacity per gram, which was mainly related to the need for further activation of the alkaline nickel-zinc button cell during the initial charge and discharge processes.

It needs to be noted that for different soluble calcium salts of organic acid, the cation thereof is calcium ion, and the anions thereof may be organic groups with different molecular weights. By further optimizing the addition amounts of the soluble organic calcium salt provided in the present disclosure in the zinc electrode, the comprehensive performance of the alkaline nickel-zinc battery can be further optimized and improved.

The technical features of the above embodiments may be arbitrarily combined. For brevity of description, not all possible combinations of the technical features in the above embodiments are described. However, all the combinations of these technical features should be considered as the scope of the present description as long as there is no contradiction between them.

The above examples merely illustrate some embodiments of the present disclosure, and the description thereof is relatively specific and detailed, but should not be construed as limiting the patent scope of the present disclosure. It should be noted that those of ordinary skill in the art can also make a number of variations and improvements without departing from the concept of the present disclosure, and all these variations and improvements shall fall within the protection scope of the present disclosure. Therefore, the protection scope of the present disclosure shall be subject to the protection scope defined by the claims.

1. A preparation method for a zinc electrode, comprising:
a step of dissolving a water-soluble calcium salt of organic acid in deionized water to obtain a first mixed solution;
a step of preparing slurry by mixing the first mixed solution, a water-soluble binder, a thickener, and an active material comprising zinc oxide; and
a step of preparing the zinc electrode by applying the slurry to a surface of a current collector and baking it at a high temperature.

2. The preparation method according to claim 1, wherein a content of the water-soluble calcium salt of organic acid in the first mixed solution is from 0.005 mol/L to 2 mol/L.

3. The preparation method according to claim 2, wherein the first mixed solution has a pH from 6 to 8.

4. The preparation method according to claim 3, wherein the water-soluble calcium salt of organic acid is at least one of calcium lactate, calcium acetate, calcium L-threonate, calcium gluconate, calcium benzoate, calcium glycerophosphate, calcium formate, calcium fumarate, calcium butyrate, calcium aspartate, calcium maleate, calcium propionate, calcium methanesulfonate, calcium triflate, calcium mellitate, and calcium p-toluenesulfonate.

5. The preparation method according to claim 1, wherein
a content of the active material is from 80 wt. % to 97 wt. %, based on a total weight of the water-soluble calcium salt of organic acid, the water-soluble binder, the thickener, and the active material; and
a total content of the water-soluble binder and the thickener is from 1 wt. % to 5 wt. %, based on the total weight of the water-soluble calcium salt of organic acid, the water-soluble binder, the thickener, and the active material.

6. The preparation method according to claim 5, wherein the water-soluble binder is a rubber-based binder or a polymer resin-based binder.

7. The preparation method according to claim 6, wherein
the rubber-based binder is at least one of styrene-butadiene rubber, acrylonitrile-butadiene rubber, acrylic rubber, butyl rubber, and fluororubber;
the polymer resin-based binder is at least one of polytetrafluoroethylene, ethylene propylene copolymer, polyethylene oxide, polyvinylpyrrolidone, polyepichlorohydrin, polyphosphazene, polyacrylonitrile, polystyrene, ethylene propylene diene copolymer, polyvinylpyridine, chlorosulfonated polyethylene, latex, polyester resin, acrylic resin, phenolic resin, epoxy resin, and polyvinyl alcohol; and
the thickener is at least one of sodium carboxymethylcellulose, hydroxypropyl methylcellulose, methylcellulose, sodium alginate, β-cyclodextrin, sodium starch phosphate, hydroxypropyl starch, gelatin, and xanthan gum.

8. The preparation method according to claim 1, wherein the baking it at the high temperature is performed at a temperature from 100° C. to 180° C. and for 5 min to 5 h.

9. A zinc electrode prepared by the preparation method according to claim 1.

10. Use of the zinc electrode according to claim 9 in an alkaline nickel-zinc battery.
